(19) United States
(12) Patent Application Publication
(10) Pub. No.: US 2010/0192317 A1
(43) Pub. Date: Aug. 5, 2010

(54) Pipeline Pig With Wear-Resistant Inserts

(76) Inventor: Kenneth M. Knapp, Houston, TX (US)

Correspondence Address: TIM COOK, P.O. BOX 10107, LIBERTY, TX, 77575, US

(21) Appl. No.: 12/693,022

(22) Filed: Jan. 25, 2010

Related U.S. Application Data
(60) Provisional application No. 61/149,048, filed on Feb. 2, 2009.

(51) Int. Cl. B08B 9/04

(52) U.S. Cl. 15/104.061

(57) ABSTRACT

A pipeline pig includes a plurality of inserts in spaced apart relationship around the periphery of a disk or a cup. The inserts are formed of a material that is compatible with the material of the pig, either the same material or a different material. Molded within the inserts are a random distribution of wear resistant material elements, i.e. a material that is harder than the material from which the insert is molded and harder than the material of the disk or the cup.

### This application claims the benefit of U.S. Provisional application Ser. No. 61/149,048 filed Feb. 2, 2009.

### FIELD OF THE INVENTION

The present invention relates generally to the field of pipeline pigs, and, more particularly, to pipeline pig for the removal of deposits on the inside surface of a pipeline including wear-resistant inserts molded into the contact surfaces of the pig.

### BACKGROUND OF THE INVENTION

Pipeline pigs have long been used to clear debris from inside pipelines. Typically, a pipeline pig includes either a rigid or a flexible cylindrical body, one or more disks, and one or more cups, or a combination of disks and cups. A cup commonly serves to pull or push a pig through the pipe, and the one or more disks serves to wipe the interior surface of the pipe.

Pipeline pigs exhibit a number of failure modes. One of the most common failure modes involves the erosion of the outer peripheral edges of the disks or the cups, or both. As the pig is propelled by fluid through the pipeline, the outer edges of the pig components abrade against the pipe, and eventually the pig erodes to the point where it will no longer properly carry out its functions, or it will no longer travel properly through the pipe because of leak-by of the driving fluid.

Thus, there remains a need for a pipeline pig that reduces the rate of erosion of the outer or peripheral edges of the pig components. The present invention is directed to filling this need in the art.

### SUMMARY OF THE INVENTION

The present invention provides a pipeline pig defined by a plurality of inserts in spaced apart relationship around the periphery of a disk or a cup. The inserts are formed of a material that is compatible with the material of the pig, either the same material or a different material. Molded within an insert is a wear resistant material, i.e. a material that is harder than the material from which the insert is molded and harder than the material of the disk or the cup. In the present invention, an insert is formed in a mold, then machined to define a desired shape. A plurality of inserts is then placed within a mold to define a cup or a disk, held in place with a compatible silicone or other material. The polyurethane or other material is then poured into the mold to define the cup, with the wear resistant inserts in place.

The wear resistant material may be tungsten carbide, ceramic, PTFE, polyethylene, molybdenum, graphite, or other material capable of molding into the insert. The wear resistant material is randomly distributed throughout the insert, so that the insert is not eroded or worn as much as a disk or cup would wear but for the insert.

These and other features and advantages of this invention will be readily apparent to those skilled in the art.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is a side section view of a pipeline pig wherein the present invention may find application.

FIG. 2 is a perspective view of an insert, constructed in accordance with the teachings of the present invention.

FIG. 3 is a perspective view of a cup which may form a component part of a pig, including a plurality of inserts of FIG. 2.

### DETAILED DESCRIPTION OF PREFERRED EMBODIMENTS

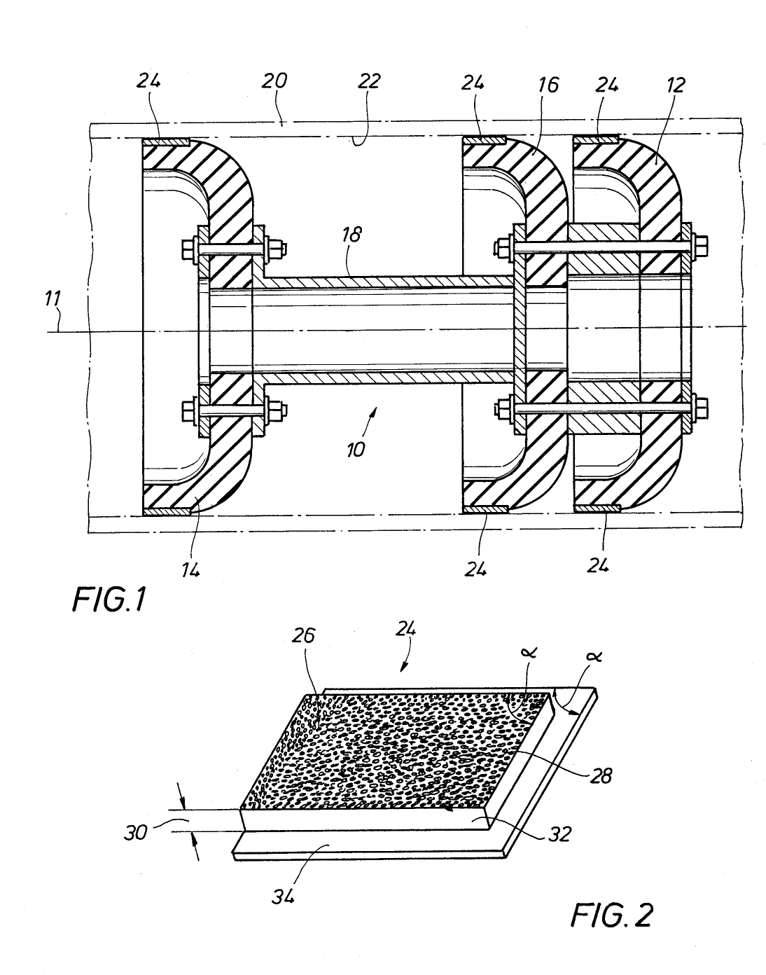

FIG. 1 depicts a side section view of a pig 10 in which the wear resistant insert of the present invention may find application. Those of skill in the art will recognize that the pig illustrated in FIG. 1 is but one example of a pig that may use the invention, and many other arrangements may use such inserts within the scope and spirit of this invention. The pig 10 comprises primarily a front cup 12, a back cup 14, and an intermediate cup 16. An axially oriented mandrel 18 extends along an axis 11 and between and joins the back cup 14 and the intermediate cup 16. The cups 12, 14, and 16 are preferably formed of a flexible, polymeric material, such as for example polyurethane, while the mandrel 18 may be formed of an inflexible material, such as metal, or a flexible material, such as polyurethane or other appropriate material. Also, disks may be used in place of or in addition to the cups shown. Thus, as used herein, the term radially extending elements encompasses cups, disks, and other elements extending outwardly from the center axis of the pig.

To simplify the description, other known components of the pig 10 which hold the pig together are shown in FIG. 1 but are not described herein.

The pig 10 in operation is forced through a pipe 20 defining an inside surface 22. The peripheral edges of the cups 12, 14, and 16 contact the inside surface 22 and in moving through the pipe, the edges are typically abraded by the inside surface 22. To solve this drawback in the art, a plurality of wear resistant inserts 24 are molded into the cups in a manner described below.

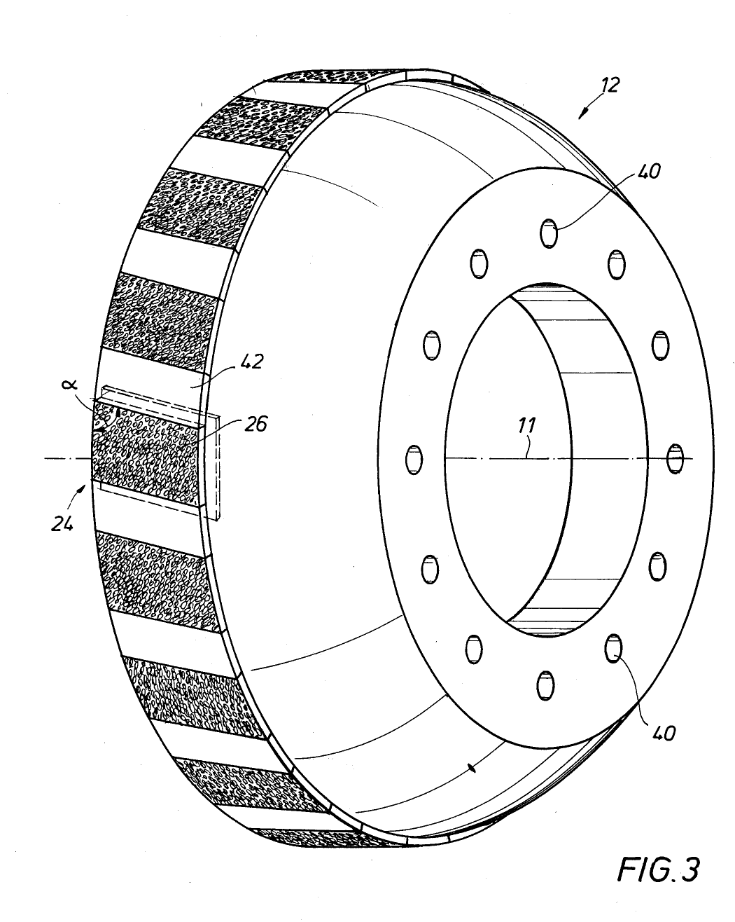

FIG. 2 depicts a presently preferred insert 24 in accordance with this invention. The insert 24 comprises a top surface 26 with a plurality of wear resistant material elements 28 exposed on the top surface. The top surface 26 is supported on a body 32 defining a thickness 30 of polymeric material, preferably polyurethane, from which the insert is formed. Extending from the body 32, and formed contiguously therewith, is a laterally extending flange 34. Preferably, the insert 24 is molded as a three-dimensional parallelogram and then machined to define the flange 34. Also, note that the top surface 26 and the flange 34 are not rectangular, but rather each defines as acute angle α, shown more clearly and described below in respect of FIG. 3.

It should be clear to those of skill in the art that the wear resistant material elements 28 may be selected according to the desired application of the pig. Ceramic beads may be used, for applications where a long life for the pig is desired, but little abrasion of the inside surface of the pipe 20 is called for. For more abrasive applications, tungsten carbine wear resistant material elements may be used, while also substantially extending the expected lifetime of the pig.

FIG. 3 illustrates an example of a radially extending element, in this case a cup 12. The cup 12 is aligned along the axis 11 and includes a plurality of through holes 40 for securing the cup 12 to other elements of the pig 10. FIG. 3 also illustrates one of the wear resistant inserts 24 molded into the cup 12. The insert 24 is positioned so that the top surface is substantially flush with an edge surface 42 extending around the periphery of the cup. Since the wear resistant elements 28 in the insert 24 is more resistant to wear than the material from which the cup 12 is made, and thus the edge surface 42, the insert 24 prevents the wear of the edge surface as the pig moves through a pipe.

In manufacture, the insert 24 may be molded in the form illustrated in FIG. 2. Preferably, however, the insert is molded as a parallelogram and then machined to form the flanges 34. Once a number of inserts have been made, the inserts a placed around the inside surface of a cup mold, or similar mold to define a radially extending component of a pig, and held in place with a silicone compound or similar compatible material. The cup material, such as polyurethane, is then poured into the mold, molding the wear resistant inserts in place.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

I claim:

1. A pipeline pig comprising:
a. an axial body; and
b. a radial member joined to the body, wherein the radial member includes a plurality of spaced apart inserts with a random distribution of wear resistant elements molded into the inserts.

2. The pig of claim 1, wherein the radial member comprises a cup.

3. The pig of claim 1, wherein the radial member comprises a disk.

4. The pig of claim 1, wherein the wear resistant elements are selected from the group consisting of tungsten carbide, ceramic, PTFE, polyethylene, molybdenum, and graphite.

5. A pipeline pig comprising:
a. an axial body; and
b. a radial member joined to the body, wherein the radial member comprises:
i. an outer edge along a periphery of the radial member and;
ii. a plurality of spaced apart inserts arranged around the edge, the inserts defining a random distribution of wear resistant elements molded into the inserts, the inserts further defining an upper surface positioned for contact with an inside surface of a pipe, the upper surface having edges defining a parallelogram including an acute angle.

6. The pig of claim 5, further comprising a flange extending outwardly from the insert.

7. The pig of claim 5, wherein the radial member comprises a cup.

8. The pig of claim 5, wherein the radial member comprises a disk.

9. The pig of claim 5, wherein the wear resistant elements are selected from the group consisting of tungsten carbide, ceramic, PTFE, polyethylene, molybdenum, and graphite.
